(19) United States
(12) Patent Application Publication
(10) Pub. No.: US 2017/0372734 A1
(43) Pub. Date: Dec. 28, 2017

(54) MAGNETIC RECORDING HEAD UTILIZING FOCUSED OPTICAL-THERMAL ENERGY AND A SYSTEM AND METHOD OF USE

(71) Applicant: Symphonious Technologies, LLC, Saint Louis Park, MN (US)

(72) Inventor: Kwaku Eason, Saint Louis Park, MN (US)

(73) Assignee: Symphonious Technologies, LLC, Saint Louis Park, MN (US)

(21) Appl. No.: 15/426,903

(22) Filed: Feb. 7, 2017

Related U.S. Application Data
(60) Provisional application No. 62/354,589, filed on Jun. 24, 2016.

(51) Int. Cl. G11B 5/48; G11B 5/00

(52) U.S. Cl. CPC G11B 5/4866; G11B 2005/0021

(57) ABSTRACT

A recording head is disclosed herein comprising: a magnetic write pole configured to induce a magnetic field into a recording media, and wherein the magnetic field is configured to only alter a thermalized portion of the plurality of magnetic particles; a waveguide embedded within the magnetic write pole; an optical transducer affixed to the proximal end and configured to receive and project optical energy from the waveguide into the recording media. A system and method of using the recording head disclosed herein comprising the steps of: the magnetic write pole inducing a magnetic field into the recording media; the waveguide guiding optical energy to the optical transducer; the optical transducer focusing optical energy and thermalizing the recording media by projecting optical energy into the recording media; and the magnetic field altering the thermalized plurality of magnetic particles.

### CROSS-REFERENCE TO RELATED APPLICATION(S)

The present application claims priority to U.S. Provisional Patent Application No. 62/354,589 filed on Jun. 24, 2016, entitled “NOVEL SYSTEM FOR THE FOCUSING OF OPTICAL-THERMAL ENERGY AND THE LIKE,” the entire disclosure of which is incorporated by reference herein.

### BACKGROUND OF THE INVENTION

### 1. Field of the Invention

The present invention relates to hard-disk drive recording technology and related devices, utilizing magnetic or optical recording processes. Specifically, the present invention relates to recording devices where the recording process utilizes an optical system to support the magnetic or nonmagnetic recording of data into a magnetic or nonmagnetic media. Further, the present invention relates to a recording head, where the recording head is capable of focusing optical energy into a well-confined region of the recording media.

### 2. Description of Related Art

Information is written to a storage media as it moves past the write head operating very close to a magnetic surface. In the field of magnetic recording, the write head is used to modify the magnetization of the recording media. In conventional recording heads used in magnetic data storage devices, only a magnetic field is required to be induced from the recording head to support the magnetic recording process. A write head magnetizes a region of the recording media by generating a strong local magnetic field. For conventional perpendicular or in-plane magnetic media, this magnetic field must be sufficiently strong to enable local control of the magnetic particles within the recording media. In such a process, the head and media, together, achieve the process of recording data into the media.

The amount of data that can be stored on a particular media is directly proportional to the amount of surface area available on that media. Generally, information can be stored on a particular media at a fixed rate of bits per unit of surface area. One way to increase the total storage capability of a particular media is to increase its data storage per unit area ratio. Current technologies utilize recording heads that result in a low and fixed bits of recorded data per unit area of media.

Increasing the number of bits that can be written per unit area requires a reduction of the area used for a given amount of written bits. That is, the ratio of bits per unit area of the recording media is increased when the required area written upon is reduced. The number of magnetic particles within the media that is used to store recorded data must also be reduced to maintain current performance capabilities.

Using current technologies, reducing the size of magnetic particles in the recording media results in spontaneous thermally activated reversal, which occurs when magnetic particles are below a certain size. This reversal results in a corrupted media and lost data. To overcome this limitation, the magneto-crystalline and/or shape anisotropy of the recording media must be increased to enhance the thermal stability of the storage media's magnetic grains. This serves to protect the life of the written data and enhance stability while allowing more information to be written on a particular media.

However, increasing the anisotropy of the recording media utilizing current technologies increases the difficultly in controlling and/or manipulating the magnetic grains using current recording technologies. In such a configuration, magnetic field alone is insufficient because the intensified requirement for a large magnetic field to overcome the enlarged energy barrier caused by the media's required higher anisotropy. Current recording head technologies have limited magnetic field strength by the size and saturation magnetization of the recording head write-pole material added to the weaker current-generated magnetic field.

To achieve reliable data writing in such conditions, the recording head must be able to write to a recording media with high anisotropy. One approach, referred to as heat-assisted magnetic recording (“HAMR”) or thermally-assisted recording (“TAR”), requires the system to be augmented to generate the magnetic field necessary to record on high anisotropy media. In these instances, the recording media is locally heated to reduce the coercivity of the recording media so the magnetic writing field applied can reliably direct the magnetization of the recording media during the temporary magnetic softening phase of the recording media caused by the heat source.

Under current technologies, HAMR or TAR systems are added to magnetic recording heads as a separate step in the recording process and work independently of the magnetic recording head. In such a configuration, the recording head is positioned near a moving magnetic recording media. The HAMR or TAR system thermalizes the recording media before it reaches the magnetic field induced by the recording head. The thermalized portion of the recording media then passes through the magnetic field induced by the recording head. This two-step recording process leads to highly sub-optimal thermalization of the media because the thermalized media starts to cool before entering the induced magnetic field, resulting in unreliable recording.

Thus, there is a need for a well-controlled and well-confined thermalizing device integrated into the magnetic recording head of a hard disk drive or other storage device that optimally thermalizes the recording media in concert with the recording process of a magnetic head. Further, a recording head device is needed that achieves sufficient cooling to enable robust operation of the recording head. The need for such a design has heretofore remained unsatisfied.

### SUMMARY OF THE INVENTION

A recording head is disclosed herein having a magnetic write pole comprising a leading write pole wherein the magnetic write pole writes data into a recording media by inducing a magnetic field into the recording media and reordering a plurality of magnetic particles therein; an optical emitter; a waveguide comprising a distal waveguide end, a proximal waveguide end, and a waveguide interior comprising a waveguide core disposed within a waveguide cladding, wherein the waveguide interior traverse the length of the waveguide beginning at the distal waveguide end and terminating at the proximal waveguide end; wherein the optical emitter is affixed to the distal waveguide end such that optical energy emitted from the optical emitter is directed into the waveguide core; an optical transducer comprising an optical transducer core disposed between an inner transducer layer and an outer transducer layer, a distal transducer end, a proximal transducer end, wherein the optical transducer core, the inner transducer layer, and the outer transducer layer traverse the length of the optical transducer, beginning at the distal transducer end and terminating at the proximal transducer end; wherein the distal transducer end is affixed to the proximal waveguide end and configured such that the optical transducer core receives optical energy from the waveguide; wherein the recording head is configured such that optical energy is emitted from the optical emitter, passed through the waveguide core, passed though the optical transducer core, and projected into the recording media, thereby thermalizing a small portion of the recording media and the plurality of magnetic particles therein; and wherein the optical transducer is configured to thermalize the recording media within the magnetic field induced into the recording media.

A system for recording data is disclosed herein comprising a magnetic write pole configured to induce a magnetic field into a recording media, wherein the recording media comprises a plurality of magnetic particles disposed therein, wherein the recording media is located sufficiently near the magnetic write pole such that a portion of the recording media coincides with the magnetic field, and wherein the magnetic field is configured to only alter a thermalized portion of the plurality of magnetic or nonmagnetic particles; a waveguide comprising a distal end and a proximal end, wherein the waveguide is embedded within the magnetic write pole; an optical emitter affixed to the distal end wherein the optical emitter is configured to emit and direct optical energy into the waveguide; an optical transducer affixed to the proximal end and configured to receive and project optical energy from the waveguide into the recording media; and the steps of: the magnetic write pole inducing a magnetic field into the recording media, the optical emitter directing optical energy into the waveguide, the waveguide receiving optical energy from the optical emitter, the waveguide guiding optical energy to the optical transducer, the optical transducer receiving optical energy from the waveguide, the optical transducer focusing optical energy, the optical transducer thermalizing the recording media by projecting optical energy into the recording media, the magnetic field altering the thermalized plurality of magnetic particles, and the magnetic write pole altering thermalized magnetic particles within the recording media thereby writing data to the recording media.

A method for recording data into a recording media is disclosed herein comprising the steps of inducing a magnetic field into a recording media wherein the magnetic field is configured to only alter thermalized portions of the recording media and thermalizing a small portion of the recording media into which the magnetic field is induced.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an assembled view, including the downtrack direction, of an exemplary computer hard disk drive employing a magnetic recording head utilizing optical-thermal energy, according to an embodiment of the present disclosure.

FIG. 2 is an exemplary cross-sectional side view, including the downtrack direction, of an assembled magnetic recording head utilizing optical-thermal energy, according to an embodiment of the present disclosure.

FIG. 3 is an exemplary cross-sectional side view, including the downtrack direction, of a magnetic write pole of a magnetic recording head, according to an embodiment of the present disclosure.

FIG. 4 is an exemplary cross-sectional side view, including the downtrack direction, of an optical transducer, according to an embodiment of the present disclosure.

FIG. 5 is an exemplary cross-sectional side view, including the downtrack direction, of a waveguide, according to an embodiment of the present disclosure.

FIG. 6 is an exemplary flow chart diagram of the system and method of recording data, according to an embodiment of the present disclosure.

### DETAILED DESCRIPTION OF PREFERRED EMBODIMENTS

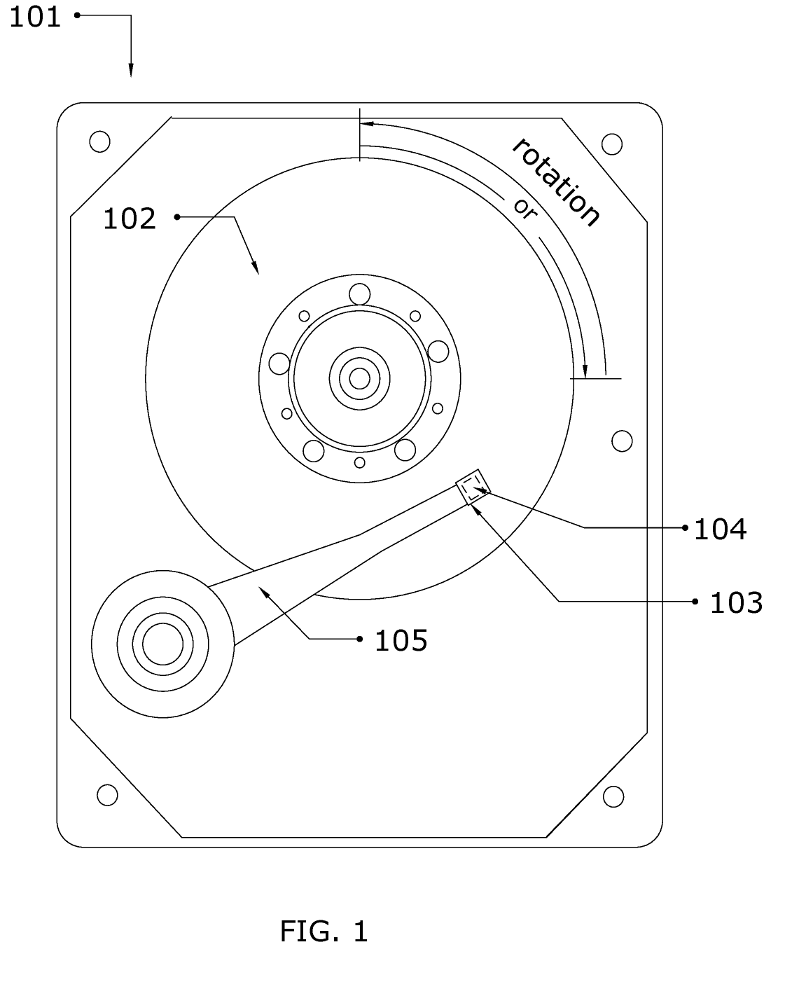

Preferred embodiments of the present invention and their advantages may be understood by referring to FIGS. 1-6, wherein like reference numerals refer to like elements.

In an exemplary embodiment of the present disclosure, the recording head comprises a magnetic write pole and an optical transducer. The optical transducer comprises a near-field transducer (“NFT”) having a metal-insulator-metal (“MIM”) structure. The MIM structure comprises at least one taper and a finite dielectric material surrounded by a plasmonically compatible material. In another embodiment of the present disclosure, the recording head comprises an optical transducer that is embedded within the magnetic write pole. In another embodiment of the present disclosure, the recording head comprises an optical transducer that is in direct contact with the magnetic write pole. In another embodiment, the NFT's MIM structure does not contain any tapered structures.

In another embodiment of the present disclosure, the NFT contains one or more tapered angles perpendicular to the recording media's surface, tapering perpendicular to the air-bearing surface and varying the cross-sectional area of the optical transducer along the perpendicular direction, ensuring the recording media is sufficiently coupled to the NFT. The NFT's angularity ensures the recording media is sufficiently coupled to the NFT and allows proper optical excitation or thermalization of the recording media in the immediate vicinity of the NFT or air-bearing surface.

In another embodiment of the present invention, the optical transducer thermalizes the recording media and lowers the media's coercivity. Simultaneously, the magnetic transducer introduces a write pole magnetization field into the media to record data to the media. In one embodiment, the optical transducer thermalizes the recording media anywhere within the magnetic field of the write pole induced into the media. In another embodiment, the optical transducer thermalizes the recording media within 30 nanometers of the write pole's magnetic field's geometric center. In another embodiment, the optical transducer thermalizes the recording media within 30 nanometers of the perpendicular magnetic field. In another embodiment, the recording head is configured such that the optical transducer thermalizes the recording media within 30 nanometers of a local maximum of the magnetic field induced into the recording media.

In another exemplary embodiment of the present disclosure, the optical transducer comprises a transducer core comprising a non-metallic material with a high index of refraction such as tantalum pentoxide or other variant of tantalum oxide. In another embodiment of the present disclosure, the non-metallic transducer core comprises silicon dioxide. In another embodiment of the present disclosure, the optical transducer comprises a metallic material surrounding the non-metallic transducer core such as gold, silver, nickel, iron, or cobalt.

In another embodiment of the present invention, the recording head comprises a magnetic transducer. The magnetic transducer comprises a magnetic and plasmonic or a plasmonic alloy of magnetic elements such as nickel, iron, and cobalt.

In an exemplary embodiment of the present disclosure, the recording head is used to write information to a recording media in a magnetic recording device such as a hard disk drive (“HDD”) or optical storage device. The recording head is located in a recording slider. The recording slider locates the recording head near a moving recording media. In one embodiment, the recording slider locates the recording head within 10 nanometers of the recording media. The recording head writes to the media by simultaneously (1) thermalizing the recording media by directing optical energy through the wave guide, through the optical transducer, into the media and (2) inducing a magnetic field into the media that alters the media's magnetic particles within the area thermalized by the optical energy. In another embodiment of the present invention, the magnetic field induced by the recording head is larger than the area thermalized by the optical transducer but the writing to the media is limited to only the area thermalized by the optical transducer.

In another exemplary embodiment of the present disclosure, the optical transducer thermalizes the recording media in the center of the induced magnetic field, in both downtrack and crosstrack directions. In another embodiment, the optical transducer thermalizes the recording media at the local maximum of the induced magnetic field. In another embodiment of the present disclosure, the optical transducer thermalizes the recording media within 30 nanometers from a peak of the magnetic field induced into the recording media. In another embodiment of the present disclosure, the optical transducer thermalizes the recording media anywhere within the magnetic field created by the recording head.

In an exemplary embodiment of the present disclosure and with reference to FIG. 1, a magnetic recording head utilizing focused optical-thermal energy (“recording head”) 104 is applied to a computer hard drive 101. A recording slider 103 is attached to a recording arm 105. The recording slider 103 is located near the recording media 102. The recording slider 103 and recording arm 105 ensure the recording head 104 is properly located relative to the rotating recording media 102.

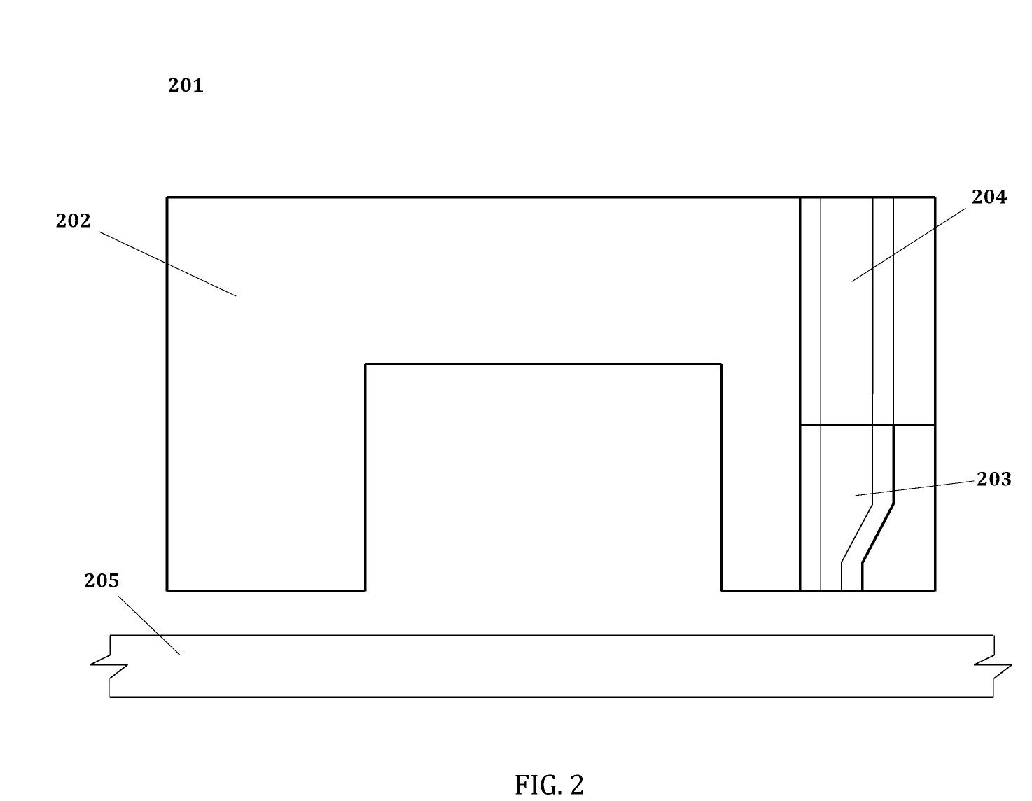

In another exemplary embodiment of the present disclosure and with reference to FIG. 2, a recording head 201 comprises a magnetic write pole 202, an optical transducer 203, and a waveguide 204. The recording head 201 is located near and writes to a recording media 205. The optical transducer 203 is embedded within the magnetic write pole 202. The magnetic write pole 202 induces a magnetic field into the recording media 205. In one embodiment, the recording head 201 is configured such that an optical emitter receives power from a power source and emits optical energy into the waveguide 204. The waveguide 204 is located above the optical transducer 203 such that optical energy from the waveguide 204 is directed into the optical transducer 203. The optical transducer 203 focuses optical energy from the waveguide 204 and directs the focused optical energy into the media 205, thereby thermalizing the recording media 205.

In another exemplary embodiment of the present disclosure, recording is limited to the area of the recording media 205 sufficiently thermalized by the optical transducer 203. The magnetic write pole 202 induces a magnetic field into the recording media 205 that is insufficient to alter non-thermalized magnetic particles within the recording media 205. The optical transducer 203 thermalizes a portion of the recording media 205 less than or equal to the portion into which the magnetic write pole 202 induces a magnetic field. The magnetic coercivity of the thermalized portion of the recording media 205 is sufficiently lowered such that the magnetic field induced by the magnetic write pole 202 writes data to the recording media 205 and that recording is limited to only the thermalized portion of the recording media 205.

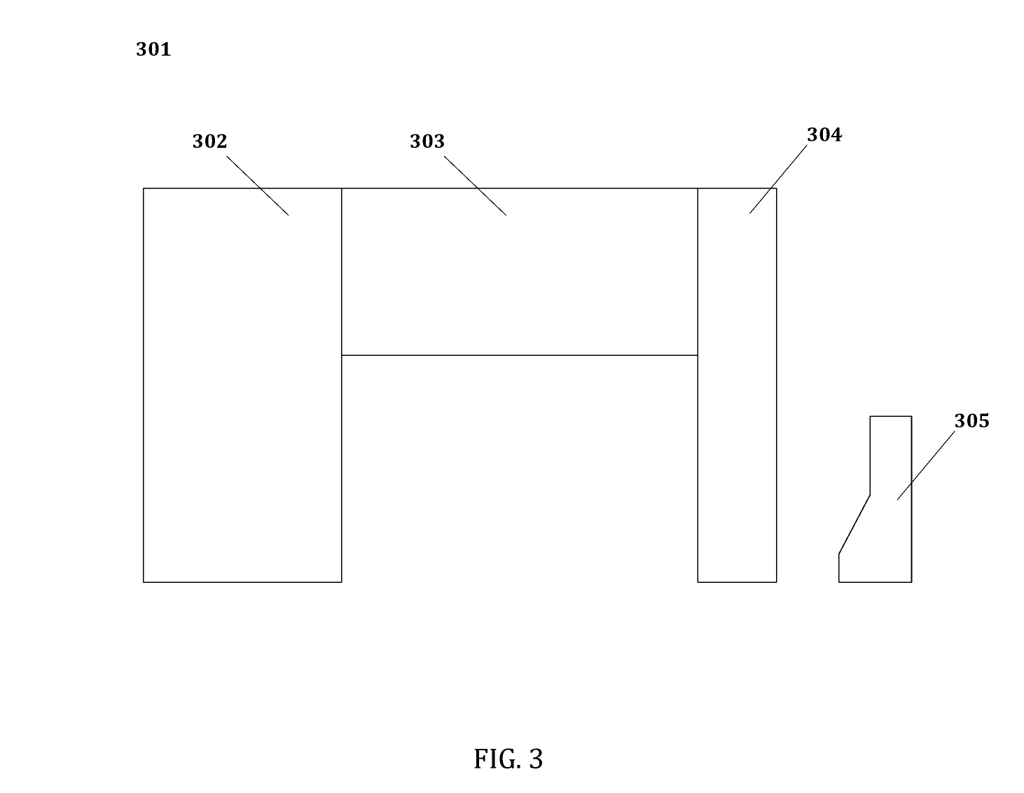

In another exemplary embodiment of the present disclosure and with reference to FIG. 3, the magnetic write pole 301 is configured to accept an optical transducer embedded within it. The magnetic write pole 301 comprises a return pole 302, a recording head yoke 303, a leading write pole 304, and a transducer cladding 305. In one embodiment, the return pole 302, the recording head yoke 303, and the leading write pole 304 are integrated and formed from one piece of magnetic metal. In another embodiment, the return pole 302 comprises a magnetic material and is affixed to the recording head yoke 303, which, in turn, is affixed to the leading write pole 304. In one embodiment, the return pole 302, recording head yoke 303, leading write pole 304, and transducer cladding 305 are made from different and magnetically compatible materials. In another embodiment, the return pole 302, recording head yoke 303, leading write pole 304, and transducer cladding 305 are made from the same magnetically compatible material. In another exemplary embodiment, the transducer cladding 305 is made from the same material as the leading write pole 304. In another embodiment, the transducer cladding 305 is made from a different and magnetically compatible material as the leading write pole 304. In another embodiment, the transducer cladding 305 comprises an angled inner surface corresponding to an embedded optical transducer. In another embodiment, the magnetic write pole 301 is configured without a metallic transducer cladding 305 thereby exposing a portion of an optical transducer to a compatible nonmetallic material.

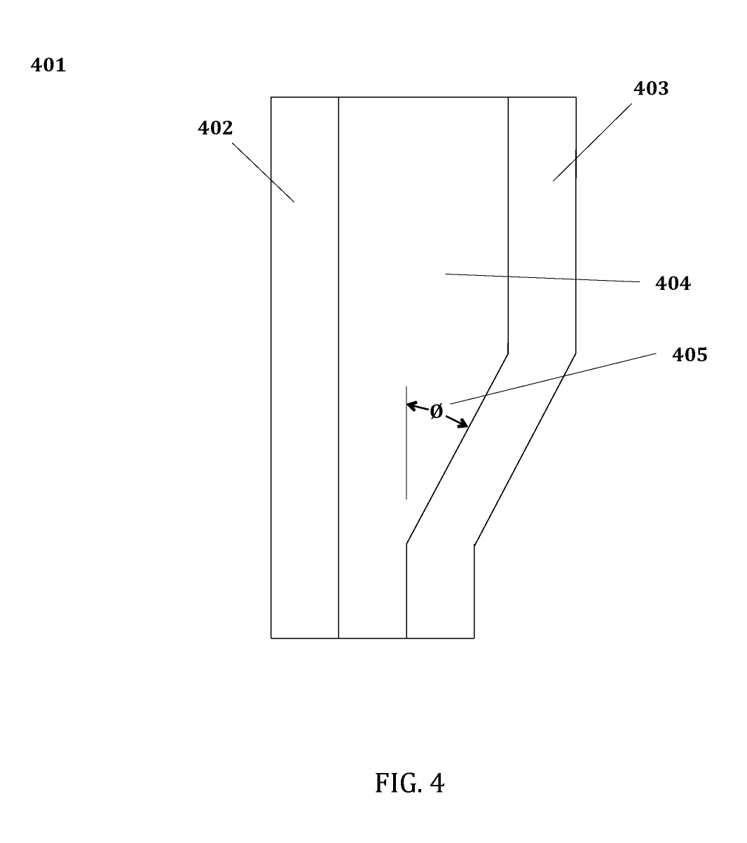

In another exemplary embodiment of the present disclosure and with reference to FIG. 4, the optical transducer 401 is configured to receive optical energy from a waveguide and focus that energy into a recording media. The optical transducer 401 comprises an inner transducer layer 402, an outer transducer layer 403 and an optical transducer core 404. In one embodiment, the optical transducer core 404 is made from a material with a high index of refraction. In another embodiment, the optical transducer core 404 is made from tantalum pentoxide. In another embodiment of the present disclosure, the optical transducer core 404 is made from silicon dioxide. In another embodiment, the inner transducer layer 402 comprises a metal that is plasmonically compatible to the optical transducer core 404 such as gold, silver, nickel, iron, or cobalt. In another embodiment, the outer transducer layer 403 comprises a plasmonically compatible material to the optical transducer core 404 such as gold, silver, nickel, iron, or cobalt. In another embodiment, the inner transducer layer 402 is made from a different material than the outer transducer layer 403. In another embodiment, the inner transducer layer 402 is in direct contact with a magnetic recording head. In another embodiment, the inner transducer layer 402 is in direct contact with a leading write pole of a magnetic recording head. In another embodiment, the outer transducer layer 403 is exposed to a nonmetallic material. In another embodiment, the optical transducer 401 is embedded within a magnetic recording head wherein the inner transducer layer 402 and the outer transducer layer 403 are affixed to the interior surface of a magnetic recording head. In another embodiment, the optical transducer core 404 is made from a plurality of materials whose composition varies over the length of the transducer core 404. In another embodiment, the outer transducer layer 403 and the inner transducer layer 402 are made from a plurality of materials whose composition varies over the length of the transducer layer 403.

In another embodiment of the present disclosure, the optical transducer core 404 and the outer transducer layer 403 comprise a tapered surface 405. In another embodiment, the tapered surface 405 comprises a taper of Ø degrees ranging from 0° to 60°, as measured from vertical. In another embodiment, the inner transducer layer 402 comprises a tapered surface ranging from 0° to 60° as measured from vertical.

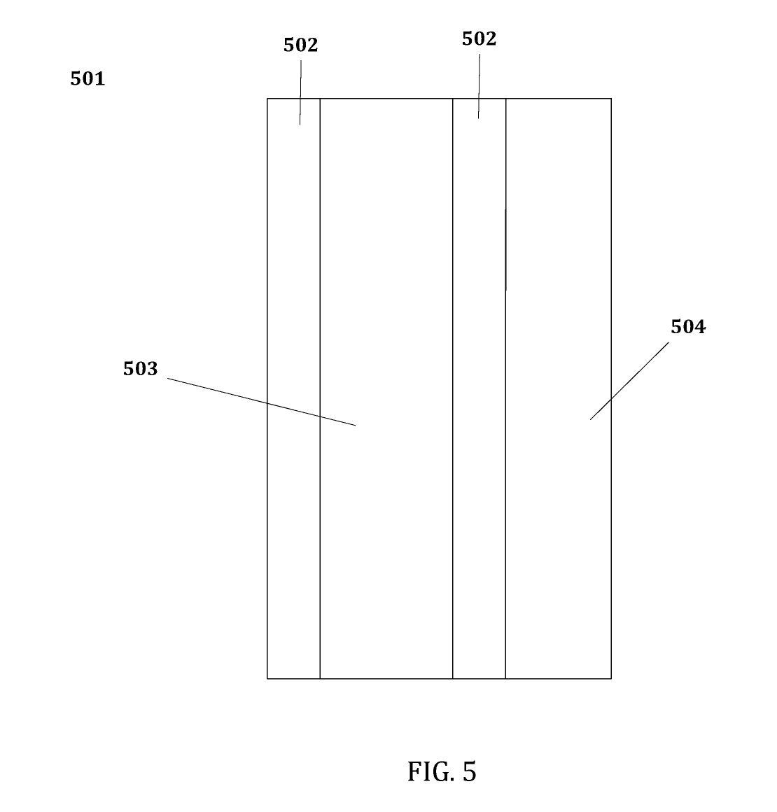

In another exemplary embodiment of the present disclosure and with reference to FIG. 5, the waveguide 501 comprises at least one optical insulating layer 502, a waveguide core 503, and a waveguide exterior 504. The optical core 503 is made from a light-transmitting material with a high index of refraction relative to the optical insulating layer 502. In one embodiment, the optical insulating layer 502 and the waveguide core 503 have an index of refraction between 1 and 2.5. In one embodiment, the waveguide 501 is attached to an optical transducer such that the waveguide 501 directs optical energy from an optical energy emitter and directs said optical energy to said optical transducer. In one embodiment, the optical energy emitter comprises a laser diode. In one embodiment, the optical energy emitter is integrated into the recording head. In another embodiment, the waveguide 501 comprises a waveguide exterior 504. In another embodiment, the waveguide exterior 504 is made from a magnetic material. In another embodiment, the waveguide exterior 504 is made from the same material of a magnetic lead write pole to which the waveguide 501 is attached. In another embodiment, the material comprising the optical insulating layer 502 varies over the length of the waveguide 501. In one embodiment, the optical insulating layer 502 comprises silicon dioxide, a metallic or magnetic material, or the same material comprising an attached optical transducer.

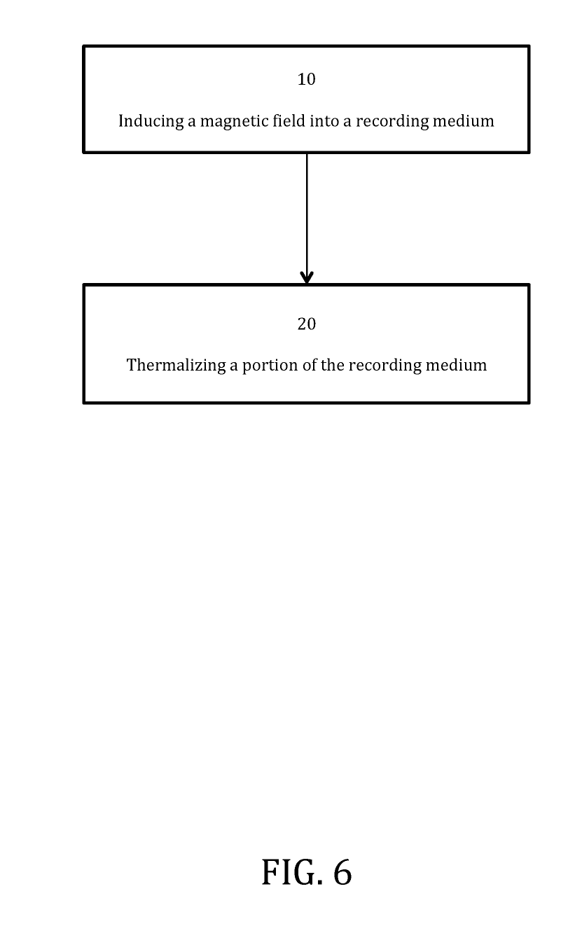

In another exemplary embodiment of the present disclosure and with reference to FIG. 6, in step 10, recording data into a recording media is achieved by inducing a magnetic field into the recording media. The magnetic field is configured such that it can only alter thermalized magnetic particles contained within the recording media.

In another embodiment of the present disclosure and with reference to FIG. 6, in step 20, recording data into a recording media containing magnetic particles is achieved by thermalizing a small portion of the recording media into which a magnetic field is induced. In one embodiment, thermalizing a small, localized portion of the recording media lowers the coercivity of the recording media within that localized portion. The magnetic field is configured to only alter data within a thermalized portion of the recording media. In one embodiment, data recording is limited to only the small, localized portion of the recording media thermalized even though the magnetic field may be induced into a much larger portion of the recording media.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A recording head comprising:
a. a magnetic write pole comprising a leading write pole wherein the magnetic write pole writes data into a recording media by inducing a magnetic field into the recording media and reordering a plurality of magnetic particles therein;
b. an optical emitter;
c. a waveguide comprising:
i. a distal waveguide end;
ii. a proximal waveguide end; and
iii. a waveguide interior comprising a waveguide core disposed within a waveguide cladding, wherein the waveguide interior traverses a length of the waveguide, wherein the length of the waveguide is defined as beginning at the distal waveguide end and terminating at the proximal waveguide end, wherein the optical emitter is affixed to the distal waveguide end and optical energy emitted from the optical emitter is directed into the waveguide core;
d. an optical transducer comprising:
i. an optical transducer core disposed between an inner transducer layer and an outer transducer layer;
ii. a distal transducer end;
iii. a proximal transducer end;
iv. wherein the optical transducer core, the inner transducer layer, and the outer transducer layer traverse a length of the optical transducer, wherein the length of the optical transducer is defined as beginning at the distal transducer end and terminating at the proximal transducer end;
e. wherein the distal transducer end is affixed to the proximal waveguide end, wherein the optical transducer core receives optical energy from the waveguide, wherein optical energy is emitted from the optical emitter, wherein optical energy passes through the waveguide core, wherein optical energy passes through the optical transducer core, wherein optical energy is projected into the recording media, thereby thermalizing a small portion of the recording media and the plurality of magnetic particles therein, and wherein the optical transducer thermalizes the recording media within the magnetic field induced into the recording media.

2. The recording head of claim 1, wherein at least one of the optical transducer or the waveguide is embedded within the magnetic write pole.

3. The recording head of claim 1, wherein at least one of the optical transducer or waveguide is affixed to the magnetic write pole.

4. The recording head of claim 3, wherein the waveguide comprises a waveguide exterior attached to the waveguide opposite the magnetic write pole and wherein the waveguide exterior is comprised of the same material as the leading write pole.

5. The recording head of claim 1, wherein the optical emitter comprises a laser diode.

6. The recording head of claim 1, wherein the optical emitter comprises a polarizer and an intensity regulator;
a. wherein the polarizer varies the polarization of optical energy emitted from the optical emitter, and wherein the intensity regulator varies the intensity of optical energy emitting from the optical emitter.

7. The recording head of claim 1, wherein the optical transducer core comprises a reduction wherein the reduction reduces the optical transducer's cross-sectional area beginning at the distal transducer end and terminating at the proximal transducer end.

8. The recording head of claim 1, wherein the magnetic field only reorders the plurality of magnetic particles thermalized by the optical transducer.

9. The recording head of claim 1, wherein the optical transducer core comprises a non-metallic material with a high index of refraction.

10. The recording head of claim 1, wherein the optical transducer core comprises a material selected from the group consisting of tantalum pentoxide and silicon dioxide.

11. The recording head of claim 1, wherein the inner transducer layer and the outer transducer layer comprise a material that is plasmonically compatible to the optical transducer core.

12. The recording head of claim 1, wherein the inner transducer layer and the outer transducer layer comprise a material selected from the group consisting of gold, silver, nickel, iron, and cobalt.

13. The recording head of claim 1, wherein the optical transducer thermalizes the recording media where the magnetic field peaks in strength.

14. The recording head of claim 1, wherein the magnetic write pole records data into the recording media using a method comprising the steps of:
a. inducing the magnetic field into the recording media wherein the magnetic field only reorders the plurality of magnetic particles that are thermalized; and
b. thermalizing a portion of the recording media and the plurality of magnetic particles disposed therein.

15. A system for recording data comprising:
a. a magnetic write pole wherein the magnetic write pole induces a magnetic field into a recording media;
i. wherein the recording media comprises a plurality of magnetic particles disposed therein;
ii. wherein the magnetic field only alters a thermalized portion of the plurality of magnetic particles;
b. a waveguide comprising a distal end and a proximal end;
c. an optical emitter affixed to the distal end wherein the optical emitter emits and directs optical energy into the waveguide;
d. an optical transducer affixed to the proximal end, wherein the optical transducer receives optical energy from the waveguide, and wherein the optical transducer projects optical energy into the recording media; and
e. the steps of:
i. the magnetic write pole inducing a magnetic field into the recording media;
ii. the optical emitter directing optical energy into the waveguide;
iii. the waveguide receiving optical energy from the optical emitter;
iv. the waveguide guiding optical energy to the optical transducer;
v. the optical transducer receiving optical energy from the waveguide;
vi. the optical transducer focusing optical energy;
vii. the optical transducer thermalizing a portion of the plurality of magnetic particles;
viii. the magnetic field altering the thermalized portion of the plurality of magnetic particles; and
ix. the magnetic write pole altering the thermalized portion of the plurality of magnetic particles within the recording media thereby writing data to the recording media.

16. The system for recording data of claim 14, wherein at least one of the waveguide, the optical emitter, or the optical transducer is embedded within the magnetic write pole.

17. The system for recording data of claim 14, wherein at least one of the waveguide, the optical emitter, or the optical transducer is attached to the magnetic write pole.

18. A method for recording data into a recording media comprising the steps of:
a. inducing a magnetic field into the recording media wherein the magnetic field only alters thermalized portions of the recording media; and
b. thermalizing a small portion of the recording media into which the magnetic field is induced.

19. The method of claim 18, wherein the steps of inducing a magnetic field into a recording media and thermalizing a small portion of the recording media occur simultaneously.
